(19) United States
(12) Patent Application Publication
(10) Pub. No.: US 2016/0098069 A1
(43) Pub. Date: Apr. 7, 2016

(54) External filter for computers/electronics

(71) Applicants: Patrice M. Baumgardner, West Pittsburg, PA (US); Gordon T. Baumgardner, West Pittsburg, PA (US)

(72) Inventors: Patrice M. Baumgardner, West Pittsburg, PA (US); Gordon T. Baumgardner, West Pittsburg, PA (US)

(21) Appl. No.: 14/505,472

(22) Filed: Oct. 2, 2014

(51) Int. Cl. G06F 1/20; B01D 46/00

(52) U.S. Cl. CPC G06F 1/206; B01D 46/0005; B01D 46/0015

(57) ABSTRACT

An external filter for the removal of: Unwanted contaminants, impurities, dust and particulates from entering the intake region of an underlying device. The filter is comprised of a filter media appropriate for separating the impurities, dust, particulates and contaminants with a surrounding collar providing structural support to the filter media. The collar is comprised of material produced from paper/cardboard and/or plastic materials, The collar will be applied to the filtering media with an adhesive that will be applied to the filter media and to nonstick film.

### BACKGROUND OF THE INVENTION

Clean air is critical for our electronics environments. For example computers and other electronic devices generate a large amount of heat requiring cooling by fan driven airflow.

In order to maintain proper operation of computers and small electronic devices the intake air flow must be filtered in order to remove dirt, dust, moisture, animal dander and other particulate materials from the air before it enters the intake regions.

Filtering media may be manufactured from substantially flexible non-woven fibrous pads of either natural or synthetic origin that are capable of entrapping particulate matter contained within the intake air-flow passing through the filtering media.

Such filtration products commonly comprise an assembly of the filtering media with a support structure surrounding its perimeter. These structures are commonly comprised of metal, plastic, wood, cardboard frame or brackets. These structures provide a means to secure the filtering material over the air intake ports of the underlying device with the use of screws, clips or other mechanical fasteners. The use of mechanical fasteners and/or a filter assembly bracket require precise drilling of holes in the intake region substrate. Example: U.S. Pat. No. 6,793,715 issued to Sandberg et al.

There is also the use of glue and adhesives for example: U.S. Pat. No. 5,827,340 Fiske show the use of double-sided tape included in a “kit” to affix the filter media to the air intake ports of an electronics component. U.S. Pat. No. 6,276,426 Polak which showed pressure sensitive adhesive with a removable liner, as in U.S. Pat. No. 3,458,130, U.S. Pat. No. 3,521,630 and U.S. Pat. No. 6,800,106 issued to Cogar which shows the adhesive used to attach his 3 ply intake filter with heat alarm. U.S. Pat. No. 7,976,606 Nicholson, provides a filter assembly and a method of preparing the filter assembly with the use of a self-adhesive material and a binding solution to create a support collar sticky on one side and non-sticky on the other that surrounds the filter media.

These filtering assemblies containing self-adhesive support frames require both a frame that must be constructed and applied to the filter media then the application of pressure-sensitive adhesive to the frame to mount it to underlying device. In addition, such assemblies relying on double sided tape prompts the need for an installer to secure the tape to the filter assembly frame before application of said frame to the underlying device. These processes, if not done properly, can allow unfiltered air to pass into the intake through cracks or gaps in the seal.

There are also efforts made in the industry to make filter assemblies and kits without a support frame or bracket. U.S. Pat. No. 6,171,354 issued to Johnson outlines a filter for a HVAC system air intake comprising a piece of filer media to which a pressure-sensitive adhesive is applied across one entire face in a discontinuous pattern of dots.

U.S. Pat. No. 4,600,420 issued to Wydeven et al. outlines a HEPA filter for a computer disk drive comprising a mesh overlaid on top of the HEPA media. A latex resin is selectively applied to both sides of the non-filtering side of the mesh to fill the voids in the mesh to form a structural support. This requires an adhesive ring with a release liner to be separately applied to one face of the latex resin structural support, so that the filter assembly can be secured to the underlying computer cabinet.

Although the filter assemblies known within the industry are capable of being affixed to an underlying device, they all need either a support frame or using pressure sensitive adhesive or double-sided tape or air-permeable adhesive or adhesives applied in discontinuous patterns to the entire face of the filter media that does not include a support frame.

It would revolutionize the industry to provide a completely assembled filter comprised of a support collar, with adhesive applied uniformly across the support collar to simultaneously adhere to the filter media as well as providing an airtight seal to the air intake port of the underlying device, in a convenient peel and stick, easily replaceable format without the need to mechanically alter or open the underlying device.

### SUMMARY OF THE INVENTION

This is a completely constructed filter, designed to be disposable using a peel n stick application process. It is comprised of a filter media appropriate for segregating and separating particulates, dust, dander, impurities and contaminates from an intake air flow with a surrounding support collar composed of a plastic, resin and/or cardboard material. It is designed to have an adhesive like but not limit to a pressure sensitive adhesive applied uniformly to the collar then pressed onto the filter media to form a seal leaving the outer edges of the frame free of filter material and at the same time coated with adhesive, the filter will be covered with a non-stick film to protect the adhesive on the outer edge of the collar until it is applied to an underlying device.

### DESCRIPTION OF THE DRAWINGS

FIG. 1. Is and overhead view of the completed filter of the present invention.

FIG. 2. Is a side view of the filter depicting a curved design.

FIG. 3. Is another side view of the filter, depicting a flat design.

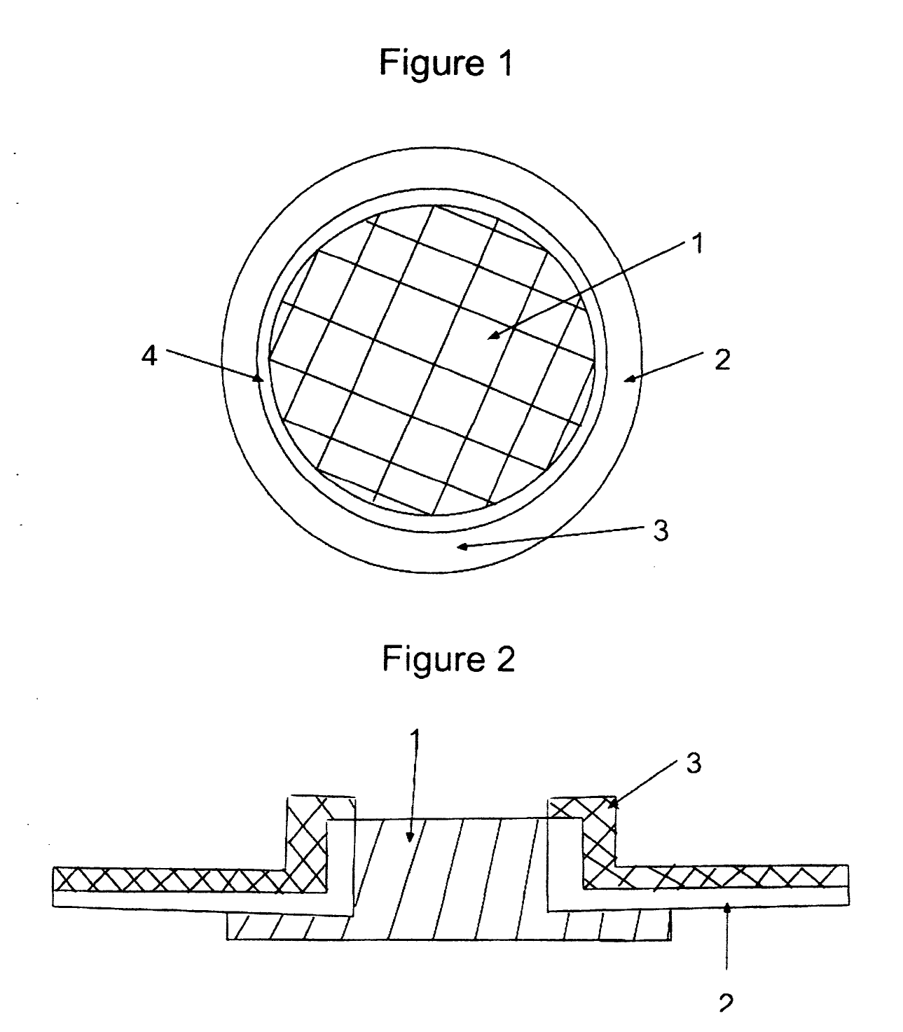

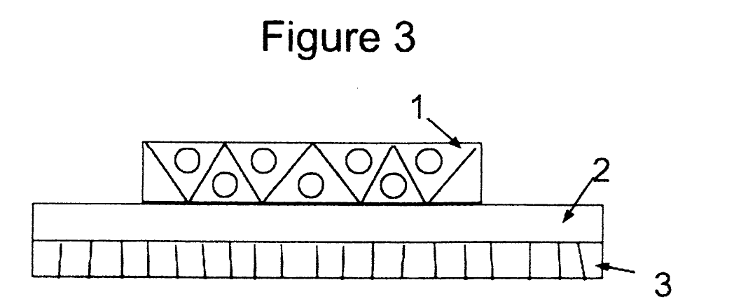

FIG. 1 shows the filers media 1 surrounded with a collar 3 that was coated with adhesive 2. The lip 4 acts to secure filter media 1 when the filter media 1 is thick without compromising the seal to an underlying device. FIG. 2 is a side view of the present invention showing the filter media 1 secured to a lipped collar 3 with adhesive 2 then to the non-stick film 4. Note the extension of the collar 3 and adhesive 2 beyond the filter media 1 to leave a portion of the collar 3 with adhesive 2 exposed beyond the filer media 1. This is the segment of the collar 3 with adhesive 2 that will attach to the non-stick film 4 before being attached to an underlying device. FIG. 3 is a side picture of the current invention showing the use of a flat collar 3 coated with adhesive 2 with the layer of filter media 1. This view allows you to see clearly the exposed collar 3 with adhesive 2 that will attach to an underlying device. This flat collar 3 would-be used for thinner filter media 1 so the seal of the collar 3 is not compromised when it is attached to the underlying device.

### DESCRIPTION OF THE PREFERRED EMBODIMENT

For the purpose of the present invention “Intake air flow” pertains to air. In the context of the present invention “underlying device” means any article of manufacture or equipment to which air is introduced as a natural material, cooling, ventilation or processing stream. Examples of such devices include but are not limit to computers and computer components, processors, disk drives, lap tops, note books, video games as well as small electronic appliances hair dryers and vacuum cleaners. Also used within this application, “contaminant or impurity” indicates any solid or liquid material that may cause abrasion, corrosion, deterioration or malfunctioning of a device or parts within the underlying device or its performance. Possible contaminants or impurities are but not limited to particulate water vapor, dust, pet dander and hair.

Presented is a filter for removing unwanted contaminants and impurities from any intake air flow entering the intake region of an underlying device to which such filter is secured is provided by this invention. The filter comprises a filter media appropriate for segregating and separating the impurities and contaminants from the intake air flow, and a surrounding collar. The collar is comprised of a plastic or paper product that will have the entire surface of one side coated with adhesive. The adhesive side of the collar will be secured to the filter media covering the filter media's outer edges at the same time leaving an overhang of collar and adhesive. The overhang of the collar will act as the adhesive fastener. The filter is then covered with a non-stick film to protect the adhesive until it is attached to an underlying device.

The filter media may be made from a woven mesh material containing strands or fibers arranged in a criss-cross or other arrangement for defining apertures of an appropriate size. The woven mesh may be made from any material that is appropriate for the intake air flow. Examples not limited to is nylon, polyester, polyethylene or natural fibers like cotton, cellulose, combinations of natural and synthetic material as well as microfiber weave.

The filter media may be comprised of a non-woven material including but not limited to polyester foam, reticulated foam and P.P.I. rated polyester filter material.

The filter shown in FIG. 1 is a circle, it should be understood that a plurality of geometric shapes like square, star, rectangle, oval etc. may be used for the purposes of this invention. For example the case for a computer may have a 3×3″ square air intake opening requiring a square filter while a blow dryer may have a 10″ in diameter opening requiring a circular filter.

The filter can vary in size depending on the dimensions of the openings of the intake ports that need filtration. For example a lap top may have an air intake area of 8×1″and a computer case may contain an air intake area of 3×2″each requiring a different size to effectively cover the intake openings.

The adhesives may be chosen from a wide variety of non-removable and removable pressure-sensitive adhesive; thermoset, and contact adhesive materials Pressure sensitive adhesives include methacrylic-based adhesive, poly-olefin based adhesive, silicone-based adhesive, presthermo-set adhesive contact adhesive, removable adhesive, methacrylic-based, modified methacrylic, poly (alpha) olefin based adhesive, synthetic or natural rubber, silicone-based, hexane. Adhesives are chosen in fabrication that will best adhere to the underlying device.

The collar is comprised of paper products such as but not limited to cardboard or materials such as but not limited to, plastic, plastisols, resins, waxes, rubber-latex, silicone, elastomers or epoxies, natural, synthetic or combination thereof. The composition of the collar is based on the best support structure needed for the filter media to perform a desired function.

The enclosed specifications and drawings provide a complete description of the structure, manufacturing process and end use of the present invention. Following is the claim hereinafter appended.

1. A fitter for attachment to an under lying device covering an air intake region within the underlying device for separating unwanted contaminants or impurities and particulates from the air flow entering such intake region.
a. A fitter media comprised of woven and/or non-woven material
b. A filtering region defined in a central portion of the fitter media.
c. A collar comprised of plastic and/or paper, cardboard.
d. A non-stick film application to protect adhesive of said filter until use on an underlying device.

2. The filter of claim 1, wherein the filter media is comprised of a woven mesh.

3. The fitter of claim 1, wherein the fitter media is comprised of non-woven material.

4. The filter of claim 1, wherein the adhesive material comprises a pressure-sensitive adhesive.

5. The fitter of claim 1, wherein the adhesive material comprises a thermo-set adhesive.

6. The fitter of claim 1, wherein the adhesive material comprises a contact adhesive.

7. The filter of claim 1, wherein the adhesive material comprises a removable adhesive.

8. The filter of claim 1, wherein the adhesive material is selected from a group consisting of methacrylic-based adhesive, modified methacrylic adhesives, poly (alpha) olefin-based adhesives, synthetic rubber based adhesives and silicone-based adhesives.

9. The filter of claim 1, wherein the intake air flow is air.

10. The filter of claim 1, wherein the underlying device is a computer or small electronics product.

11. The fitter of claim 1, wherein the contaminant or impurity removed by the filter from the air intake flow is particulate material from air.

12. The filter of claim 1, wherein the contaminant removed by the fitter from the air intake flow is water vapor from air.

13. The fitter of claim 1, wherein the collar is constructed of paper/cardboard.

14. The fitter of claim 1, wherein the collar is constructed of plastics.

15. The fitter of claim 1, wherein a non-stick film is used to protect exposed adhesive on the filter.

16. The filter of claim 1, wherein the collar is raised or flat depending on the thickness of the filtering media needed to perform its desired function.
